(19) United States
(12) Patent Application Publication
(10) Pub. No.: US 2005/0284834 A1
(43) Pub. Date: Dec. 29, 2005

(54) Crane balancing system

(76) Inventor: Hans-Dieter Willim, Ulm-Unterweiler (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/154,291

(22) Filed: Jun. 15, 2005

(30) Foreign Application Priority Data
Jun. 16, 2004 (DE) 20 2004 009 497.5

(51) Int. Cl. B66C 23/72

(52) U.S. Cl. 212/178

(57) ABSTRACT

The present application relates to a crane balancing system that includes at least one balance element with at least one uninterrupted opening, at least one installation device with an elongate element for the insertion into the at least one opening in the at least one balance element, and a lifting device to lift up the entire installation device, whereby the at least one opening in the at least one balance element and the installation device feature connection devices that lock into each other.

### CROSS REFERENCE TO RELATED APPLICATION

This application claims priority to German Utility Model Application Serial No. DE 20 2004 009 497.5 filed Jun. 16, 2004, which is hereby incorporated by reference in its entirety for all purposes.

### FIELD

The present application relates to a crane balancing system utilized for lifting and attaching balancing elements as counter weights to a crane and to the removal of this system from the crane.

### BACKGROUND AND SUMMARY

Known solutions for the attachment of balancing elements as counter weights on a crane utilize a system whereby balancing plates, made, for example, from concrete secured by ropes attached to pull-through tabs extending from the balancing plates, are placed upon a base platform, which reaches out from the back of the crane in the opposite direction of the crane weight. As a rule, several balancing plates are placed upon each other to achieve the required total counter weight. The ropes are removed from the pull-through tabs by installation workers, who have to climb on top of the thus created balancing pile. Especially in the winter months this creates an increased occupational accident hazard due to the increased risk of falling. Moreover, it is frequently very difficult to precisely align the balancing plate to be added with the balancing plates that have already been piled upon the platform.

One purpose of the present application here presented is to introduce a crane balancing system that allows for a simple and uncomplicated placement and removal of the balancing elements while at the same time reducing the accident risk.

The disclosed crane balancing system features at least one balancing element with at least one uninterrupted opening. In addition, an installation device has been designed, which encompasses an elongate element which can be guided through the at least one opening in the at least one balancing element. Moreover, the installation device features a lifting device designed to lift up the entire installation device. The opening in the at least one balancing element and the installation device each feature connection devices that lock into each other.

The disclosed crane balancing system allows for the simple and uncomplicated placement and removal of balancing elements as counter weights. To initiate the installation process, the installation device is guided through the at least one opening in a balancing element and is coupled with the lifting device with the help of the connection device in the opening. Subsequently, the entire installation device is lifted up at the lifting device. Thanks to the fact that the installation is locked together with the balancing element, the latter is lifted simultaneously and can be placed upon the crane as a counter weight. The unlocking of the connection and the pulling out of the installation device from the balancing element opening complete the process. By repeating this process, it is possible to place as many balancing elements as desired onto the balancing pile. The disclosed crane balancing system can of course also be used to remove the balancing elements from the balancing pile or to uninstall the crane.

As a rule, several balancing elements are typically required, which are placed upon each other to create the balancing pile, thus creating a different counter weight depending on the number of elements piled upon each other. It is particularly easy to pile plate-shaped balancing elements upon each other.

The special advantages of the disclosed crane balancing system are particularly evident during the picking up process of balancing elements from a balancing pile: during the installation of the crane, i.e. for example during the picking up of balancing elements from for example a transportation vehicle for placement upon the balancing pile as a counter weight for the crane or during the break-down of the crane during the picking up of balancing elements from the crane's balancing pile for placement on a transportation vehicle.

A simple design of the lifting device for the lifting of the installation device calls for an eyelet in the shape of an S, into which a crane hook can be hooked to perform the lift up process.

In a particularly practical advanced development of the disclosed crane balancing system the elongate element of the installation device features a centering device, which preferably has a pointed end pointing toward the bottom. Such a centering device facilitates the exact placement of a balancing element on the balancing pile. For this kind of design, the centering device can be designed in such a way that it allows for sliding, so that it is pushed together when the installation device is entered into the opening, if the installation device touches an object below, for example the base platform for the balancing elements, as it is pushed through the opening.

The locking between the installation device and the opening of a balancing element can be achieved in numerous ways. For example, suitable shafts can be approached in a radial fashion from the installation device. A particularly simple solution is, however, a design that features a non-circular opening in the at least one balancing element and an installation device with a counter part, which fits into the non-circular opening if it is placed into the opening in one alignment but not in any other. To secure the lock, the counter part reaches sideways beyond the elongate element of the installation element and features an outer edge, which does fit into the non-circular opening in a first setting and does not fit in a second setting. To this end, the design allows for the adjustment of the first and second settings through the turning of the elongate element around its longitudinal axis. After guiding the elongate element through the opening, the turning of the installation device around the longitudinal axis of the elongate element results in the locking of the counter part into the opening of the balancing element.

A particularly simple design is a design that features an installation device with at least one slide shaft, which reaches beyond the exterior side of the elongate device and the at least one opening of the at least one balancing element features a slit, through which this slide shaft can be guided as the installation device is guided through the opening. In this design, the turning of the installation device around the longitudinal axis of the elongate element results in the locking of the slide shaft into the opening of the balancing element. This design can be constructed easily, for example through pressing the slide shaft into the elongate element.

The design of a crane balancing system with a centering device and a slide shaft in the installation device allows for the hanging of the centering device in a certain design onto this slide shaft. This creates a cost-effective solution that can be easily installed. The centering device in this case also features, for example, an axial elongate hole.

Another advantageous design calls for a triangular opening in the at least one balancing element and for a triangular counter part on the installation device's connection device. In this design, the installation device featuring the counter part is initially guided through the triangular opening. By turning the device 60 degrees around the longitudinal axis of the elongate element of the installation device, the counter part is locked into the balancing element. The advantage of this kind of design is that the surface pressure on the layers is reduced and the relevant balancing element can be held in a horizontal position more easily, given that there are three support points.

It will be appreciated that an opening with more than three corners can be used in the same fashion, provided that a matching counter part is created.

Markings indicating the locked position of the installation device into the balancing element on the surface of the balancing element are helpful. This makes it easy to identify when the elements have been securely locked into each other and the balancing element can be lifted up with the installation device.

To simplify matters, the installation device may feature a turning device allowing the turning around its longitudinal axis. This device can for example be a foldable lever, which can be easily operated by a worker.

It is advantageous to design the elongate piece of the installation device in such a length that allows it to be guided through not just one balancing element opening, but through the openings of several balancing elements lying on top of each other. This allows for the simultaneous lifting or weight placement of one or several balancing elements, depending on the requirements. To this end, the elongate element may feature a sliding and lockable stop, which can be adjusted in such a way that a continued penetration of the top balancing element by the installation device is prevented, if the installation device has entered far enough into the balancing element pile.

To simplify matters, the turning direction can be moved together with the stop in the longitudinal direction of the elongate device.

It is particularly advantageous to ensure that the locking devices, especially the counter pieces on the installation devices do not reach beyond the balancing elements at the bottom when they are in locked position in the openings. Especially in scenarios where some elements are to be removed from a balancing pile consisting of several balancing elements or if a number of balancing elements are to be placed on an already existing balancing pile, a counter piece extended at the bottom would be a hindrance. This can be easily achieved through recesses in the openings that are open toward the bottom.

Several uninterrupted openings can be provided for each balancing element, through which the appropriate number of installation devices is guided to lift the balancing element. This is particularly advantageous if one of the openings is placed in the balancing element's center of gravity, which is, as a rule, in its center point, allowing for the use of just one installation device.

To secure the individual balancing elements of a balancing pile against slipping, it is beneficial to design the crane balancing in such a way that it features grooves/shafts, washer faces and/or recesses that fit into appropriate counter parts in an additional balancing element to laterally lock the elements together. Grooves may for example be provided on the surface of the balancing element, which fit into shafts on the bottom of another balancing element. A similar lateral fixation can also be achieved through counter-piece washer faces.

A cylinder-shaped or tubular installation device is particularly easy to produce and easy to turn in the openings. Such designs are also suitable for the insertion of a centering element.

The figures show:

### BRIEF DESCRIPTION OF THE FIGURES

FIG. 1 is a cross-sectional view of an installation device for the disclosed balancing system according to one embodiment of the present invention.

FIG. 2 is a top side view of an installation device of FIG. 1.

FIG. 3 is a side view of a balancing plate of the disclosed balancing system according to one embodiment of the present invention.

FIG. 4 is a top view of the balancing plate of FIG. 3.

FIG. 5 is a front elevational view of the disclosed balancing system, in operation.

FIG. 6 is a side elevational view of the balancing system of FIG. 5, in the viewing direction VI indicated therein.

FIG. 7 is a top view of a balancing plate of the balancing system, according to another embodiment of the present invention.

FIG. 8 is a perspective view of an installation device for the embodiment of the balancing system shown in FIG. 7.

### DETAILED DESCRIPTION

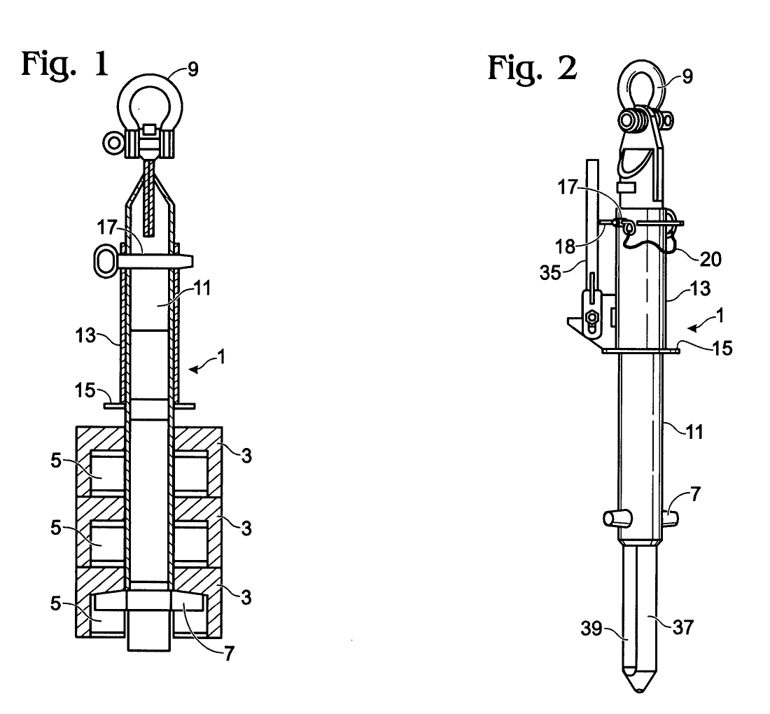

Initially, the installation device is explained based on FIGS. 1 and 2.

The installation device includes an elongate, tubular shaped element 11 with two radial bores, into which a radial bolt 7 is pressed. A centering element 37 with a tip pointing to the bottom, featuring an elongate hole 39, which reaches to the top into the tubular element 11 and encompasses the radial bolt 7, hangs on this radial bolt. The centering element 37 may be moved along the entire length of the elongate hole 39 in axial direction of the elongate element 11. An eyelet 9 is located at the upper end of the elongate element 11. A crane hook may be inserted into the eyelet. An additional tube 13 is placed over the elongate element 11, which features a washer face 15. A foldable lever 35 is attached to the tube 13. The tube 13 may be fixated to the elongate tube 11 with the assistance of a bolt 17, which can be pushed through the openings, which are covered up in the FIG. 2 by tube 13 and therefore not visible in the figure. This fixation allows the setting up of clearances between the stop 15 and the radial bolt 7 at different heights. The bolt 17 can be secured as shown via pin 18, which can, for example, be held in place with the assistance of a cord 20.

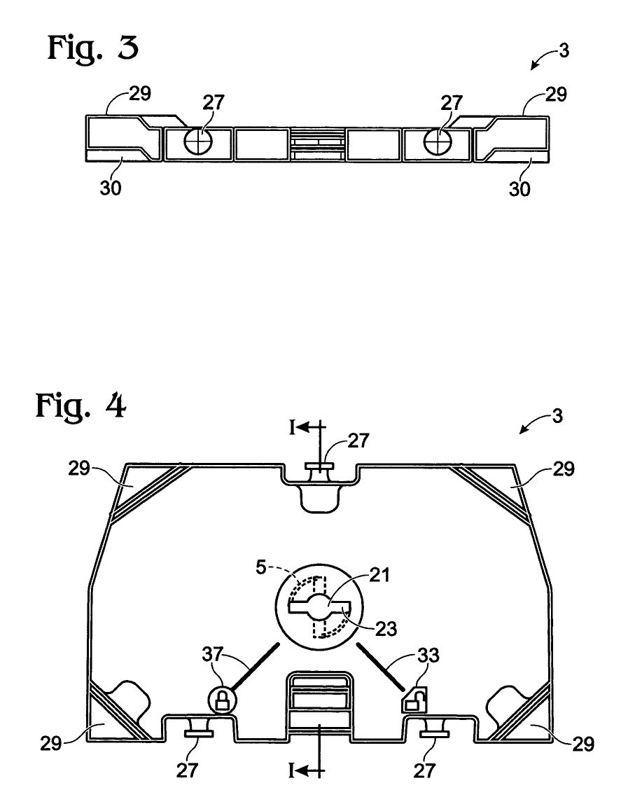

A balance plate 3 of the disclosed balancing system is shown in a side view in FIG. 3 and in top view in FIG. 4. The uninterrupted opening 21 with side slits 23 is especially visible. The opening 21 is therefore shaped in such a way that the tube 11 and the radial bolt 7 of the installation device 1 can be guided through. The bottom part of the balance plate 3, which is not visible in FIG. 4, features a groove 5, the dimensions and layout of which are designed in such a way that the radial bolt 7 of the installation device 11 can be turned within it, into a locked position.

This embodiment features washer faces 29 pointing upwards in the corners of the balance plate 3. On the bottom of the ballast element relevant recesses 30 have been prepared that fit the dimensions of the washer faces 29 on top. This allows the laying of several identical ballast elements 3 on top of each other while being protected against slips to the side. Relevant lateral fixation devices can also be created via taper keys and grooves that lock into each other.

In this type of embodiment the disclosed balance plates 3 feature additional attachment hooks 27, which can be used to lift up a balance element 3, if a suitable installation device is not on hand.

On the surface of the balance elements 3 markings 31, 33 are provided, which show in which direction an installation element 1 guided through the opening 21 must be turned to lock or unlock it. Marking 31 shows for example a closed lock, while marking 33 shows an open lock. The markings can be added, for example as embossed symbols in the balancing plate. An appropriate counter marking can be provided on installation device 1 to allow proper alignment. A particularly easy solution is to have the foldable lever 35 point in the direction of marking 31 when the system is locked and into the direction of marking 33 when it is unlocked.

FIG. 1 shows an installation 1 in a position where it has been guided through three balance plates 3 and locked with the lowest of these three balance plates. The viewing direction of the cut through the balance plates 3 is shown in FIG. 4 and identified by marking I.

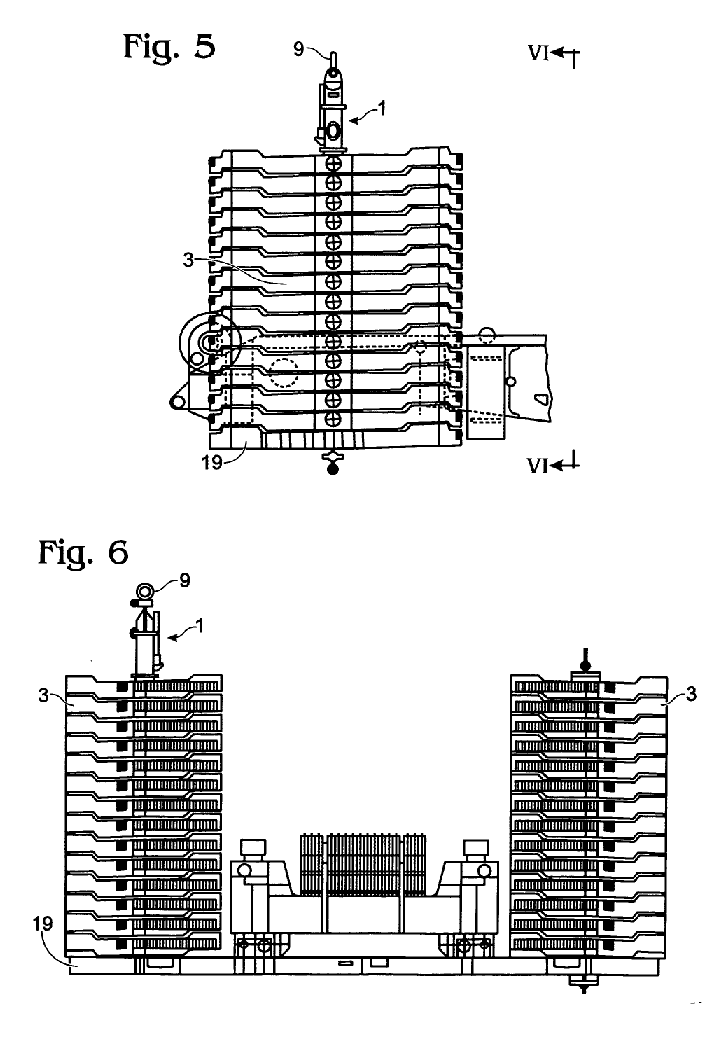

FIGS. 5 and 6 show the disclosed balancing system used on a crane with two balancing piles. The side view of FIG. 5 shows how the installation device 1 is guided through the balancing pile. In the back view of FIG. 6, which is identified as VI in FIG. 5, the installation device 1 can be identified in the left balancing pile. The right-hand balancing pile is completely installed. The balancing plates are lying on top of base plate 19.

The disclosed balancing system is to be utilized as follows.

Prior to beginning the work, it has to be decided how many balancing plates are to be lifted up simultaneously with installation device 1. The clearance between the radial bolt 7 and the washer face 15 of installation device 1 is then set up accordingly and fixated with bolt 17. As an example, a crane is used to pick up the installation device 1 at the eyelet 9 of the installation device 1 and the installation device is inserted into the central opening 21 of the balance elements on the pile with the center tip 37 going in first until the washer face 15 rests on the surface of the uppermost balance element. To this end, the radial bolt 7 is guided through the side slits 23 of openings 21. The lever is folded down and the installation device is turned around the longitudinal axis. To do this, lever 35 is, for example, moved from a position pointing in the direction of marking 33 on the uppermost balance plate 3, into a position that points into the direction of marking 31 of the uppermost balance plate 3. By performing this turn around the vertical axis, the radial bolt 7 in recess 15 turns into a position as shown in the cut view of FIG. 1. The installation device is therefore locked at the bottom of the three shown balance plates 3. With the help of the crane the entire installation device can then be lifted up at eyelet 9, so that the balance plates 3 located between the radial bolt 7 and the recess 15 are lifted up along with it.

The installation device 1 with the attached lifted up balance elements 3 is now lifted over the balancing pile on the crane onto which these balance elements are to be placed. With the assistance of the centering device 37 it is easily possible to center and lower the balance elements to be placed onto the balancing elements that are already on the pile. The only thing that has to be adjusted is the angle direction of the balance elements to be placed on the elements on the existing pile before the balance elements are lowered into their final position. With the help of the foldable lever the installation device 1 is once again turned back by 90 degrees around its vertical axis, so that the foldable lever 35 points into the direction of marking 33.

This done, the radial bolt 7 is now again flush below the insertion slits 23 in opening 21 so that the installation device 1 can be pulled up from the openings 21 of the balance plates 3. The safe and hazard-free placement of the additional balance plates is then complete.

In terms of the removal of the balance elements 3 from the balance pile on the crane to place them for example on a transportation vehicle, the breakdown of the crane is performed in the same way as the aforementioned set up.

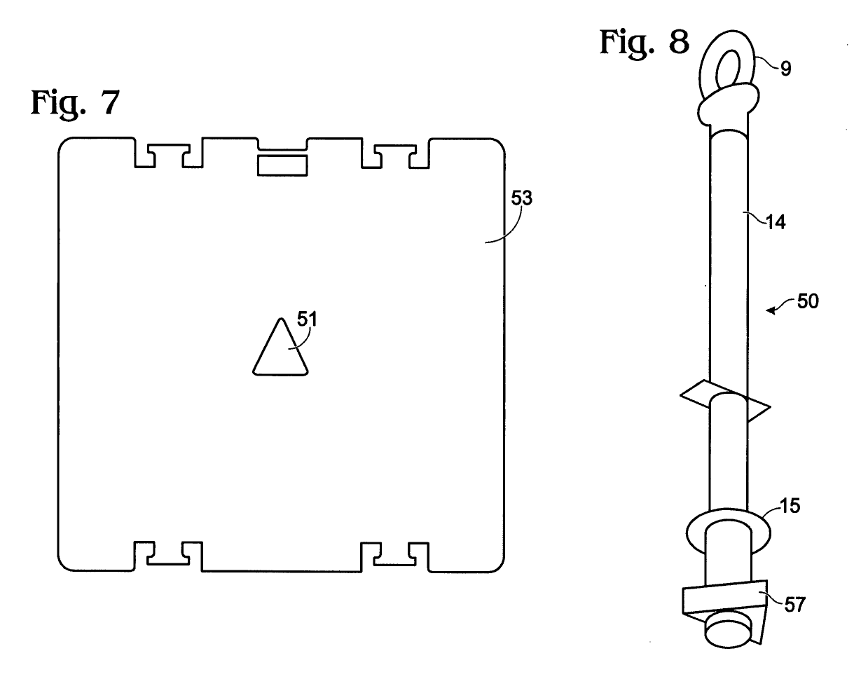

FIGS. 7 and 8 show a different embodiment of the disclosed balancing system. In this case, balance plate 53 features a triangular opening 51. The installation device 50 with the elongate element 11 also features a matching counter part 57, the outer shape of which is also triangular and dimensioned to fit through the opening 51 of balance plate 53 in one position. FIG. 8 shows a schematic sketch of a washer face 15, which can be designed similarly to the one earlier described as the first embodiment. The installation device of FIG. 8 also features an eyelet 9 to allow the picking up of the assembly. Although the embodiment shown in FIG. 8 does not show this, the installation device of this embodiment can also feature a centering device equal to the centering device 37 referenced in the balancing system described in FIGS. 1 to 4.

An embodiment according to FIGS. 7 and 8 is utilized in the same way as the embodiment referenced in FIGS. 1 to 4. The installation device 50 in this case is guided through the opening 51 of balance plates 53 in such a way that counter piece 57 fits through the opening. Once the installation device 50 has been inserted into the pile of balance plates until it meets with stop 15, the installation device 50 is turned around its longitudinal axis by 60 degrees. This causes counter piece 57 to lock into a balance plate 53, securing this balance plate and the balance plates above it in such a way that they can be lifted up together as described for the embodiment referenced in FIGS. 1 to 4.

1. A crane balancing system comprising:
at least one balance element with at least one uninterrupted opening;
at least one installation device with an elongate element configured to be guided through the at least one opening in the at least one balance element; and
a lifting device configured to perform lifting of the entire installation device;
whereby at least one opening in the at least one balance element and the installation device are equipped with connection devices that lock into each other.

2. The crane balancing system pursuant to claim 1, wherein the installation device includes a centering device that is tapered into a tip pointing downward, which is located along a length direction of the elongate element along its entire length, and which is configured to be used for centering the at least one opening of the balancing element.

3. The crane balancing system pursuant to claim 2, further comprising a centering device that can be slid in the length direction of the elongate element.

4. The crane balancing system pursuant to claim 1, further comprising:
an opening in the at least one balance element, the opening not being circular; and
an installation device with a counter piece fitting the opening, whereby the counter piece reaches beyond the sides of the elongate element of the installation device and has an exterior shape that fits into the non-circular opening in a first position, and does not fit into the opening in a second position, whereby this position can be attained by turning the elongate element from the first position around a longitudinal axis of the elongate element, so that the installation device in the opening of the balance element can be locked into the installation device by turning the elongate element.

5. The crane balancing system pursuant to claim 4, further comprising
at least one radial bolt in the installation device as a counter piece to the opening, which reaches beyond the elongate element to the exterior on the sides;
wherein the at least one opening of the at least one balance element includes an insertion slit for the insertion of the radial bolt configured such that the installation device can be locked with the at least one radial bolt in the opening of the balance element by turning the elongate element of the installation device around its longitudinal axis.

6. The crane balancing system pursuant to claim 5,
wherein the radial bolt of the installation device is uninterrupted; and
wherein the centering device hangs on the radial bolt.

7. The crane balancing system pursuant to claim 6, wherein the centering device includes an elongate hole that is extended axially in the longitudinal direction of the elongate element.

8. The crane balancing system pursuant to claim 4, wherein the opening in the at least one balance element is triangular.

9. The crane balancing system pursuant to claim 4, further comprising markings on the surface of the at least one balance element indicating lock settings of the installation device in the balance element.

10. The crane balancing system pursuant to claim 4, wherein the installation device includes a turning device for turning the installation device around a longitudinal axis of the installation device.

11. The crane balancing system pursuant to claim 10, wherein the turning device is a foldable lever.

12. The crane balancing system pursuant to claim 1, wherein the elongate element of the installation device has a length that is equal or greater to twice the thickness of the at least one balance element.

13. The crane balancing system pursuant to claim 10, wherein the elongate element includes a movable and stoppable stop, which does not fit through the at least one opening of the at least one balance element.

14. The crane balancing system pursuant to claim 13, wherein the installation device is configured to allow for the simultaneous movement of the turning device with the stop in the longitudinal direction of the elongate element of the installation device.

15. The crane balancing system pursuant to claim 1, wherein the at least one balance element is plate shaped.

16. The crane balancing system pursuant to claim 1, wherein the at least one opening in the at least one balance element includes a recess in a bottom of the balance element, the recess being configured to receive the connection device that locks in the installation device in such a manner that the connection device does not reach beyond the bottom of the balance element.

17. The crane balancing system pursuant to claim 1, wherein the opening for the insertion of the elongate element of the installation device is provided substantially at the center of gravity of the balance element.

18. The crane balancing system pursuant to claim 1, wherein the at least one balance element includes grooves and taper keys, washer faces and/or recesses on a top and a bottom of the at least one balance element, which are configured to interlock with corresponding counter elements of another balance element for lateral fixation.

19. The crane balancing system pursuant to claim 1, wherein the elongate element of the installation device is cylinder shaped.

20. The crane balancing system pursuant to claim 1, wherein the elongate element of the installation device is tubular.

21. The crane balancing system pursuant to claim 1, wherein the lifting device includes an eyelet for lifting of the installation device.
